(19) United States
(12) Patent Application Publication
(10) Pub. No.: US 2007/0131144 A1
(43) Pub. Date: Jun. 14, 2007

(54) Water-based pigment preparations

(76) Inventors: Martin Alexander Winter, Kandem (DE); Bjoern Fechner, Eppstein (DE); Klaus Peter Kreutzer, Nidderau (DE); Hans Joachim Metz, Darmstadt (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/576,594

(22) PCT Filed: Oct. 20, 2004
(86) PCT No.: PCT/EP04/11852

§ 371 Date: Sep. 13, 2006

(30) Foreign Application Priority Data
Oct. 29, 2003 (DE) 103 50 556.3

(51) Int. Cl. C09D 11/00; C09D 11/02; C09B 67/50; C09C 1/44; C08K 5/00; C09B 48/00; C09B 27/00

(52) U.S. Cl. 106/504; 106/31.86; 106/31.89; 106/31.66; 106/31.67; 106/413; 106/474; 106/477; 106/493; 106/494; 106/495; 106/496; 106/497; 106/498; 106/499

(57) ABSTRACT

The invention relates to aqueous pigment preparations containing: (A) at least one organic and/or inorganic pigment, (B) at least one polyethylene glycol alkyl ether functionalised by a terminal acid group, (C) at least one alkoxylated styrol-phenol condensate, (D) at least one polyethylene glycol ether having an average molar mass of between 200 and 1000 g/mol, (E) at least one alkine diol, (F) fats and oils of plant and/or animal origin and/or saturated and unsaturated higher fatty acids of such fats and oils and/or salts of such saturated and unsaturated higher fatty acids, (G) optionally an aqueous acrylate resin solution, (H) optionally a polymer condensation product of aromatic sulfonic acids and formaldehyde and/or salts of aromatic sulfonic acids and formaldehyde, (I) optionally one sulfonsuccinic acid half-ester of a castor oil alkoxylate, (J) optionally a hydrotropic substance, (K) optionally other standard additives for aqueous pigment preparations, and (L) water.

The present invention relates to waterborne pigment formulations, to processes for their production, to their use for coloring macromolecular materials of any kind, for example natural and synthetic fiber materials, preferably cellulose fibers, especially for paper pulp coloration.

It has been established art for about 40 years for organic chromatic pigments to be used for paper pulp coloration. For use in paper pulp coloration, the hydrophobic pigments are dispersed with surfactants and various addition agents in water. Such an aqueous dispersion is readily incorporable in the pulp (mixture of water, cellulose and titanium dioxide) from which the paper is formed. However, unlike direct dyes, organic and inorganic-pigments have no affinity for cellulose fibers. Without use of further chemical auxiliary agents, the dispersed pigments would be washed off the fibrous web which forms on the papermachine fabric and would build up in the papermachine's circuit loop. Therefore, the pigments have to be flocculated. Cationic epichlorohydrin resins primarily are used as retention aids or wet strength agents to achieve flocculation and ideally complete retention of anionically charged pigments. The cationic epichlorohydrin resins combine with the pigments to form agglomerates, known as flocs, which have an external cationic charge due to bridging and patching. Retention aids will flocculate not just the dispersed chromatic pigments, but also titanium dioxide and fine fiber fractions. The flocs bind by ionic interactions and hydrogen bonding to the cellulose fibers and are retained as a result.

The dispersants and add materials used for dispersing the hydrophobic pigments have a decisive influence on the process of flocculation. The flocs are more or less shear sensitive, depending on the identity of the anionic and neutral surfactants used, the resulting pigment charge and also the identity of the cationic polymer used for flocculation. In recent years, papermachine speed has risen significantly. While average machine speeds used to be 200-250 m/min, decorative paper machines are now running at 600-800 m/min. As a result, the shearing stresses for the pigment flocs in the pumps and on the wet end of the machines have likewise increased. Once a floc has been destroyed it can scarcely still be retained in the fibrous web after neutralization of the external cationic charge. The consequence is a decrease in the color strength and higher staining of the circuit loop water used. Color corrections become necessary, consuming time and resources. The resulting unstable machine conditions result in large quantities of broke and time wasting.

The high shear rates of the pulp which result from the high operating speeds of the papermachines raise the flocculation or shear stability requirements for optimum retention of the pigment. Prior art aqueous pigment formulations for paper pulp coloration often do not meet the paper industry's requirements. Frequently, such pigment formulations contain anionic and/or nonionic surfactants as a dispersant. In general, these surfactants are alkylaryl compounds and their alkoxylation and sulfonation products. The poor resistance to shearing is the greatest problem with these commercial pigment formulations. Many existing pigment formulations incur a 5-15% color strength loss in state of the art decorative paper machines under severe exposure to shearing. At the same time, foaming is substantial and must be considered the second greatest problem. Foam appreciably impairs the pumped circulation and the flowability of the water-cellulose mixture. In addition, bursting bubbles of foam generate craters and rings of differing color strength on the paper.

Problems with existing aqueous pigment formulations for paper pulp coloration further include an insufficient stability in storage. After some period of storage, sedimentation is a frequent occurrence, or a high increase in the viscosity leads to solidification. Some formulations exhibit a pronounced structural viscosity and are thixotropic, so that they can be reliquefied under shearing stress; other formulations, by contrast, remain solid even after energetic commixing. There are many pigment dispersions where the agglomeration which ensues in the course of storage due to lack of stability on the part of the dispersed particles leads to a numerical reduction thereof and consequently to a lower color strength in paper pulp coloration. Moreover, commercial pigment formulations frequently have poor dryout resistance. The dispersions in opened packs dry very speedily to form solid crusts and clumps on lids and walls. The disadvantage is that the pigment formulations dry out inhomogeneously and too quickly, even though they contain water-retaining agents such as glycols for example, which are intended to prevent incipient or complete drying of the formulation before it is used. The crusts and clumps flake or peel off into the aqueous dispersion, causing stripes or specks on the paper in later use.

EP-B-0 065 751 paper pulp coloration formulations contain novolaks which are undesirable these days because of their potential content of secondary components such as nonylphenol. In addition, these pigment formulations are insufficiently stable to shear. Paper pulp coloration pigment formulations are further presented in the following patents: WO-A-02 095 130, EP-B-1 165 696, DE-A-197 31 572. However, these pigment formulations do not satisfy all the quality requirements discussed above.

The present invention therefore has for its object to provide aqueous pigment formulations that fulfill a slate of requirements that is distinctly superior to the prior art: the pigment formulations should possess a high shear or floc stability, so that small compact and hence shear-stable flocs are formed when the dispersed pigments combine with cationic polymers. Furthermore, the pigment formulations shall cause only very little foaming, if any, when applied under high flowrate and shearing exposure. In addition, very good retention and penetration shall be ensured in use. Moreover, the concentration of the pigments in the formulations shall be very high, generally being not less than 30%. The pigment formulations shall possess a high color strength, precisely defined coloristics with regard to hues and cleanness, a high color fastness to light, a high bleed resistance and low viscosity. A storage stability of at least two years is desired; that is, the dispersed pigments should not agglomerate and sediment within this time. In addition, these pigment formulations shall be resistant to drying on and drying out before use. Drying out over a prolonged period shall be possible, but shall proceed homogeneously, accompanied by filming. A further important criterion is that the pigment dispersions shall possess high purity, since excessively high concentrations of organic and inorganic salts and also ions have a disruptive effect in relation to the flocculation of the pigments and in relation to the retention on the fiber. Lastly, the dispersants and additives in pigment formulations should ideally be readily biodegradable and have low COD and BOD values, in order to minimize the contamination of the circuit loop water in papermaking. Ecotoxicologically impeccable pigment dispersions are substantially waterborne, containing only low or no fractions of organic solvents.

We have found that this object is achieved, surprisingly, by the combination of hereinbelow listed pigments, surfactants, additives and add materials to produce aqueous pigment formulations that meet the above-discussed quality requirements with regard to paper pulp coloration, storage and good environmental compatibility to a high degree. The aqueous pigment dispersions hereinbelow are stable to shearing, resist drying out, are stable in storage, foam little in use, if at all, and possess excellent rheology.

The present invention accordingly provides aqueous pigment formulations comprising
(A) at least one organic and/or inorganic pigment,
(B) at least one polyethylene glycol alkyl ether functionalized with a terminal acid group,
(C) at least one alkoxylated styrene-phenol condensate,
(D) at least one polyethylene glycol ether having an average molar mass between 200 and 1000 g/mol,
(E) at least one alkynediol,
(F) fats and oils of vegetable and/or animal origin and/or saturated and unsaturated higher fatty acids of such fats and oils and/or salts of such saturated and unsaturated higher fatty acids,
(G) if appropriate an aqueous acrylate resin solution,
(H) if appropriate a polymeric condensation product of aromatic sulfonic acids and formaldehyde and/or of the salts of aromatic sulfonic acids and formaldehyde,
(I) if appropriate a sulfosuccinic monoester of a castor oil alkoxylate,
(J) if appropriate a hydrotropic substance,
(K) if appropriate further add materials customary for aqueous pigment formulations, and
(L) water.

Preferred pigment formulations consist essentially of
(A) 5% to 80% by weight, preferably 20% to 70% by weight, especially 30% to 50% by weight of at least one organic and/or inorganic pigment,
(B) 0.1% to 30% by weight, preferably 1% to 15% by weight of at least one polyethylene glycol alkyl ether functionalized with a terminal acid group,
(C) 0.1% to 30% by weight, preferably 1% to 15% by weight of at least one alkoxylated styrene-phenol condensate,
(D) 0.5% to 50% by weight, preferably 1% to 20% by weight of at least one polyethylene glycol ether having an average molar mass between 200 and 1000 g/mol,
(E) 0.1% to 5% by weight, preferably 0.1% to 2% by weight of at least one alkynediol,
(F) 0.1% to 10% by weight, preferably 0.1% to 5% by weight of fats and oils of vegetable and/or animal origin and/or saturated and unsaturated higher fatty acids of such fats and oils and/or salts of such saturated and unsaturated higher fatty acids,
(G) 0% to 30% by weight, preferably 0% to 25% by weight of an aqueous acrylate resin solution,
(H) 0% to 10% by weight, preferably 0% to 5% by weight of a polymeric condensation product of aromatic sulfonic acids and formaldehyde and/or of the salts of aromatic sulfonic acids and formaldehyde,
(I) 0% to 10% by weight, preferably 0% to 8% by weight of at least one sulfosuccinic monoester of a castor oil ethoxylate,
(J) 0% to 30% by weight, preferably 0% to 20% by weight of at least one hydrotropic substance,
(K) 0% to 10% by weight, preferably 0% to 5% by weight of further add materials customary for aqueous pigment formulations, and
(L) 5% to 90% by weight, preferably 10% to 70% by weight of water, all based on the total weight of the pigment formulation.
   When one or more of the components G, H, I, J and K are present, their minimum concentration is independently advantageously at least 0.01% by weight and preferably at least 0.1% by weight, based on the total weight of the pigment formulation.

Component (A) of the pigment formulation of the present invention is a finely divided organic or inorganic pigment or a mixture of various organic and/or inorganic pigments. The pigments can be used not only in the form of dry powder but also as water-moist presscake.

Useful organic pigments include monoazo, disazo, laked azo, β-naphthol, Naphthol AS, benzimidazolone, disazo condensation, azo metal complex pigments and polycyclic pigments such as for example phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline and diketopyrrolopyrrole pigments or carbon blacks.

Of the organic pigments mentioned, those whose colorfastness to light is rated higher than 5 and especially higher than 6 against a blue standard are particularly suitable. In addition, the pigments used for producing the formulations should be in a very fine state of subdivision where preferably 95% and more preferably 99% of the pigment particles are ≦500 nm in size. Depending on the pigment used, the morphology of the pigment particles may differ very substantially, and accordingly the viscosity behavior of the pigment formulations can also be very different depending on the particle shape. To obtain an ideal, newtonian viscosity behavior for the formulations, the particles should preferably possess a shape ranging from spherical to cubic (with flattened-off corners).

An exemplary selection of particularly preferred organic pigments includes carbon black pigments, for example lamp or furnace blacks; monoazo and disazo pigments, in particular the Colour Index pigments Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34 or Pigment Brown 41; β-naphthol and Naphthol AS pigments, in particular the Colour Index pigments Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 256, Pigment Orange 5, Pigment Orange 38 or Pigment Brown 1; laked azo and metal complex pigments, in particular the Colour Index pigments Pigment Red 48:2, Pigment Red 48:3, Pigment Red 48:4, Pigment Red 57:1, Pigment Red 257, Pigment Orange 68 or Pigment Orange 70; benzimidazoline pigments, in particular the Colour Index pigments Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72 or Pigment Brown 25; isoindolinone and isoindoline pigments, in particular the Colour Index pigments Pigment Yellow 139 or Pigment Yellow 173; phthalocyanine pigments, in particular the Colour Index pigments Pigment Blue 15, Pigment Blue 15:1, Pigment Blue 15:2, Pigment Blue 15:3, Pigment Blue 15:4, Pigment Blue 15:6, Pigment Blue 16, Pigment Green 7 or Pigment Green 36; anthanthrone, anthraquinone, quinacridone, dioxazine, indanthrone, perylene, perinone and thioindigo pigments, in particular the Colour Index pigments Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23 or Pigment Orange 43; triarylcarbonium pigments, in particular the Colour Index pigments Pigment Red 169, Pigment Blue 56 or Pigment Blue 61; diketopyrrolopyrrole pigments, in particular the Colour Index pigments Pigment Red 254.

Useful inorganic pigments include for example titanium dioxides, zinc sulfides, iron oxides, chromium oxides, ultramarine, nickel antimony titanium oxides, chromium antimony titanium oxides, cobalt oxides, mixed oxides of cobalt and of aluminum, bismuth vanadates and also blend pigments.

Instead of pigment dispersions it is also possible to prepare dispersions of solids including for example finely divided ores, minerals, sparingly soluble or insoluble salts, particles of wax or plastic, dyes, crop protection and pest control agents, UV absorbers, optical brighteners and polymerization stabilizers.

Component (B) is preferably a compound of the formula (I): 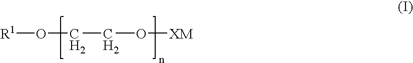
where
R¹ is a substituted or unsubstituted, branched or unbranched C₁-C₂₀-alkyl or C₃-C₂₀-cycloalkyl radical or a substituted or unsubstituted, branched or unbranched C₂-C₂₀-alkenyl or C₃-C₂₀-cycloalkenyl radical, the substituents being 1, 2, 3 or 4 radicals in the group consisting of halogen, aryl, aryl(C₁-C₂₀)alkyl, C₅-C₆-cycloalkyl, hetaryl, hetaryl(C₁-C₂₀)alkyl and C₁-C₂₀-alkoxy,
n is a number from 1 to 100, preferably 2 to 35,
X is SO₃⁻, SO₂⁻, CH₂COO⁻, PO₃²⁻ or PO₃M⁻, and
M is H, a monovalent metal cation, a divalent metal cation, NH₄⁺, a secondary, tertiary or quaternary ammonium ion, or a combination thereof.

“Aryl” here and also in the definitions hereinbelow refers to an aromatic radical which preferably contains 6 to 15 carbon atoms. Examples thereof are phenyl, naphthyl, anthryl and phenanthryl. “Hetaryl” here and also in the definitions hereinbelow refers to an aromatic radical which preferably contains 1, 2, 3 or 4 heteroatoms from the group consisting of O, N, S and P as well as 1 to 10 carbon atoms. Examples thereof are pyrrolyl, furyl, thiophenyl, indolyl, isoindolyl, indolizinyl, benzofuryl, benzothiophenyl, pyrazolyl, imidazolyl, oxazolyl, isoxazolyl, thiazolyl, isothiazolyl, triazolyl, tetrazolyl, pyridyl, quinolinyl, isoquinolinyl, pyridazinyl, pyrimidinyl, pyrazinyl and triazinyl.

In particularly preferred compounds of the formula (I), R¹ is C₁₂-C₁₈-alkyl (branched or unbranched) or C₁₂-C₁₈-alkenyl (branched or unbranched), which may each be substituted by 1, 2, 3 or 4 substituents from the group consisting of halogen, for example F, Cl or Br, aryl, aryl(C₁-C₄)alkyl, hetaryl, hetaryl(C₁-C₄)alkyl and C₁-C₄-alkoxy, X is preferably CH₂COO⁻ and M is preferably H⁺, Li⁺, Na⁺, K⁺, NH₄⁺, HO—CH₂—CH₂—NH₃⁺, (HO—CH₂—CH₂—)₂NH₂⁺ or (HO—CH₂—CH₂—)₃NH⁺.

Examples of compounds of the formula (I) are:

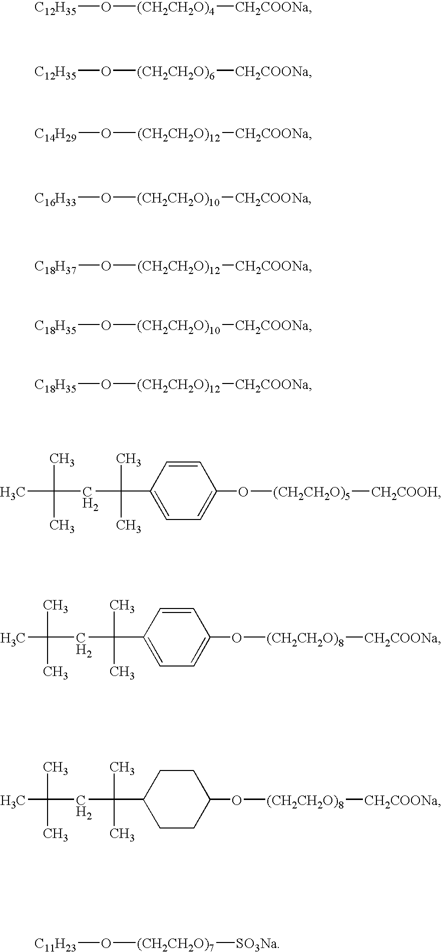

Compounds of this kind are known from CH-A-324 665 and CH-A-283 986.

Component (C) is preferably an alkoxylated styrene-phenol condensate of the formula (II) or (III) or a mixture thereof: 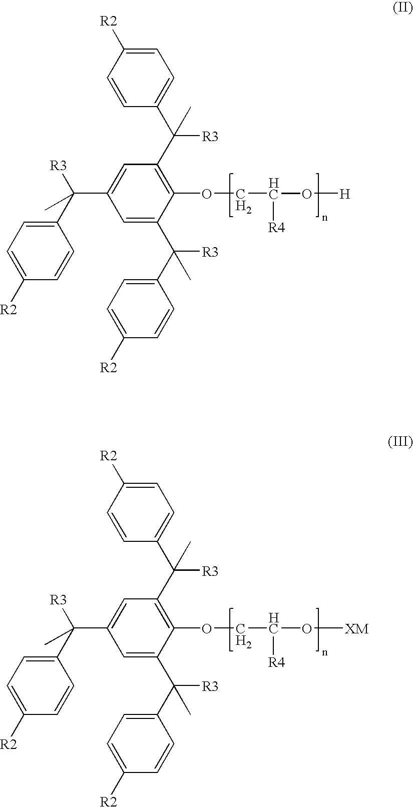
where
R² is H, a branched or unbranched C₁-C₂₀-alkyl or C₃-C₂₀-cycloalkyl radical or a branched or unbranched C₂-C₂₀-alkenyl or C₃-C₂₀-cycloalkenyl radical, preferably H or a C₁-C₄-alkyl radical,
R³ and R⁴ are independently H, a branched or unbranched C₁-C₂₀-alkyl or C₃-C₂₀-cycloalkyl radical or a branched or unbranched C₂-C₂₀-alkenyl or C₃-C₂₀-cycloalkenyl radical, preferably H or CH₃,
n is a number from 1 to 100, preferably from 10 to 60,
X is CO—R⁵—COO⁻, SO₃⁻, SO₂⁻, PO₃²⁻ or PO₃M⁻,
R⁵ is a substituted or unsubstituted, branched or unbranched C₁-C₂₀-alkylene radical, a substituted or unsubstituted, branched or unbranched C₁-C₂₀-alkenylene radical, or a substituted or unsubstituted arylene radical, the substituents preferably being 1, 2, 3 or 4 radicals from the group consisting of halogen, hydroxyl, C₁-C₄-alkoxy, nitro, cyano, carboxyl, amino and sulfo, preferably CH═CH, CH(SO₃M)—CH₂ or CH₂—CH(SO₃M), and
M is H, a monovalent metal cation, a divalent metal cation, NH₄⁺, a secondary, tertiary or quaternary ammonium ion, preferably H⁺, Li⁺, Na⁺, K⁺, NH₄⁺, HO—CH₂—CH₂—NH₃⁺, (HO—CH₂—CH₂—)₂NH₂⁺ or (HO—CH₂—CH₂—)₃NH⁺.

Compounds of this kind are known for example from DE-A-197 12 486. Component (D) comprises polyethylene glycol ethers having an average molar mass between 200 and 1000 g/mol, preferably in the range from 200 to 800 g/mol and more preferably in the range from 200 to 600 g/mol. A particularly preferred compound is an α-methyl ω-hydroxy polyethylene glycol ether of the formula (VII):
H₃C—O—[—CH₂CH₂—O—]ₙ—H (VII)
where n=9 to 22 (average).

The preferred α-methyl ω-hydroxy polyethylene glycol ether within the meaning of the present invention may further comprise fractions of nonmethylated polyglycol ether. Products of this kind are commercially available and are known from DE-A-101 33 641 for example.

Component (E) is suitably selected from compounds of the formula (IV) or (V) or mixtures thereof: 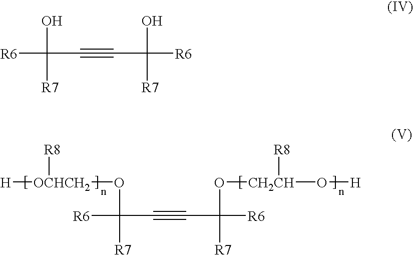
where
R⁶ is H or a branched or unbranched C₁-C₄-alkyl radical or a branched or unbranched C₂-C₄-alkenyl radical, preferably CH₃,
R⁷ is a branched or unbranched C₃-C₂₀-alkyl or C₃-C₂₀-cycloalkyl radical or a branched or unbranched C₃-C₂₀-alkenyl or C₃-C₂₀-cycloalkenyl radical, preferably a C₃-C₇-alkyl radical,
R⁸ is H, a branched or unbranched C₁-C₂₀-alkyl or C₃-C₂₀-cycloalkyl radical or a branched or unbranched C₂-C₂₀-alkenyl or C₃-C₂₀-cycloalkenyl radical, preferably H and CH₃,
n is a number from 1 to 100, preferably 4 to 40.

Compounds of this kind are commercially available as defoamer formulations.

Of the fats and oils of vegetable and animal origin of component (F), it is particularly bovine tallow, palm kernel fat, coco fat, rapeseed oil, sunflower oil, linseed oil, palm oil, soya oil, peanut oil and whale oil which is preferred. Cottonseed oil, maize oil, poppy oil, olive oil, castor oil, colza oil, safflower oil, soybean oil, sunflower oil, herring oil, sardine oil is also used. The saturated and unsaturated higher fatty acids and the salts of the saturated and unsaturated higher fatty acids of component (F) correspond to compounds of the formula (VI):
R9—COO—M (VI)
where
R⁹ is a branched or unbranched C₇-C₂₉-alkyl or a branched or unbranched C₇-C₂₉-alkenyl radical, a branched or unbranched C₇-C₂₉-alkdienyl radical, a branched or unbranched C₇-C₂₉-alktrienyl radical, and
M is H, a monovalent metal cation, NH₄⁺, a secondary, tertiary or quaternary ammonium ion.
   Particularly preferred are: palmitic acid, cyprylic acid, capric acid, myristic acid, lauric acid, stearic acid, oleic acid, linoleic acid, linolenic acid, caproic acid, caprylic acid, arachidic acid, behenic acid, palmitoleic acid, gadoleic acid, erucic acid and ricinoleic acid.

Component (G) is an aqueous, preferably 5% to 40% by weight, acrylate resin solution of dissolved polyacrylates, which were made to dissolve by using bases to neutralize the vinylic acid building blocks. The polyacrylates used constitute copolymers consisting essentially of 30 to 80 mol % of monoalkylene aromatics and 20 to 70 mol % of acrylic and/or methacrylic acids and/or esters of acrylic and/or methacrylic acid. The polyacrylates used have number average molar masses Mₙ between 1000 and 100 000 g/mol and preferably in the range from 2000 to 50 000 g/mol. Such aqueous acrylate resin solutions of dissolved polyacrylates are known from DE-A-101 35 140 for example.

The monoalkylene aromatics used for preparing these polyacrylates may be styrene, α-methylstyrene, divinylbenzene and vinyltoluene or mixtures thereof. The monomers counting as acrylic and/or methacrylic acids and/or esters of acrylic and/or methacrylic acid can consist of at least one of the following monomers: acrylic acid, methacrylic acid, itaconic acid, methyl acrylate, ethyl acrylate, n-propyl acrylate, n-butyl acrylate, isopropyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, N,N-dimethylaminopropyl acrylate, N,N-diethylaminopropyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-hexyl acrylate, n-octyl acrylate, 2-ethylhexyl acrylate, 2-phenoxyethyl acrylate, 2-phenylethyl acrylate, phenylethyl acrylate, propargyl acrylate, tetrahydrofurfuryl acrylate, tetrahydropyranyl acrylate, methyl methacrylate, ethyl methacrylate, n-propyl methacrylate, n-butyl methacrylate, isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, N,N-dimethylaminopropyl methacrylate, N,N-diethylaminopropyl methacrylate, t-butylaminoethyl methacrylate, 2-sulfoethyl methacrylate, trifluoroethyl methacrylate, glycidyl methacrylate, benzyl methacrylate, allyl methacrylate, 2-n-butoxyethyl methacrylate, 2-chloroethyl methacrylate, sec-butyl methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-hexyl methacrylate, n-octyl methacrylate, 2-ethylhexyl methacrylate, 2-phenoxyethyl methacrylate, 2-phenylethyl methacrylate, phenylethyl methacrylate, propargyl methacrylate, tetrahydrofurfuryl methacrylate, tetrahydropyranyl methacrylate.

A particularly preferred component (H) is the polymeric condensation product of the sodium salt of 2-naphthalenesulfonic acid with formaldehyde. Such polymeric condensation products of aromatic sulfonic acids and formaldehyde or salts thereof are known from EP-B-1 165 696 for example.

Component (I) is preferably a sulfosuccinic monoester of a castor oil ethoxylate and/or propoxylate or its sodium salt. Compounds of this kind are known from EP-A-0 582 928.

Component (J) is selected from hydrotropic substances. Such compounds, which also serve as a solvent, if appropriate, may be for example formamide, urea, tetramethylurea, ε-caprolactam, ethylene glycol, propylene glycol, diethylene glycol, triethylene glycol, polyethylene glycol, butylglycol, methylcellosolve, glycerol, N-methylpyrrolidone, 1,3-diethyl-2-imidazolidinone, thiodiglycol, sodium benzenesulfonate, sodium xylenesulfonate, sodium toluenesulfonate, sodium cumenesulfonate, sodium dodecylsulfonate, sodium benzoate, sodium salicylate or sodium butyl monoglycol sulfate.

Useful customary add materials (component K) include further cationic, anionic, amphoteric or nonionic surfactants and pigment-wetting agents, and also antisettling agents, preservatives, photoprotectants, antioxidants, degassers/defoamers, foam-reducing agents, fillers, grinding assistants, viscosity stabilizers and rheology improvers. Useful viscosity regulators include for example polyvinyl alcohol and cellulose derivatives. Water-soluble natural or artificial resins and also polymers may similarly be included as filming or binding agents to enhance bonding strength and abrasion resistance. Useful pH regulators include organic or inorganic bases and acids. Preferred organic bases are amines, for example ethanolamine, diethanolamine, triethanolamine, N,N-dimethylethanolamine, diisopropylamine, aminomethylpropanol or dimethylaminomethylpropanol. Preferred inorganic bases are sodium hydroxide, potassium hydroxide, lithium hydroxide or ammonia.

Water used as component (L) to produce the pigment formulations is preferably used in the form of distilled or demineralized water. It is similarly possible to use tapwater and/or water of natural origin.

The pigment formulations of the present invention are miscible with water in any proportion, even a plurality of different formulations being miscible with water. Compared with conventional pigment formulations for paper pulp coloration, they possess excellent shear stability. Even when the application medium is subjected to substantial shearing in the papermachine, color strength does not decrease at all or only to a minor extent of 4% at the most. In addition, the pigment formulations of the present invention possess high dryout resistance. They dry to form a homogeneous elastic film which does not peel or flake off into the dispersion. Accordingly, no stripes or specks are formed in use. The pigment formulations possess good stability in storage and have very little tendency to agglomerate and sediment. It is particularly noteworthy that the pigment formulations of the present invention generate only very little foam, if any, in the papermachine. Furthermore, these pigment dispersions provide very good retention and penetration in use. The pigment formulations possess high color strength, defined hues, high colorfastness to light, high bleed resistance and low viscosity featuring good rheological properties and approximately newtonian flow characteristics.

The present invention also provides a process for producing the pigment formulations of the present invention, which comprises dispersing component (A) in the form of a powder, a granulate or an aqueous presscake in the presence of water (L) and also of the components (B), (C), (D), (E) and (F) in a conventional manner, then admixing water (L) if appropriate and also if appropriate (G) and/or (H) and/or (I) and/or (J) and/or (K), and adjusting the resulting aqueous pigment dispersion with water to the desired concentration. Preferably, the components (B), (C), (D), (E), (F), (L) and if appropriate (G) and/or (H) and/or (I) and/or (J) and/or (K) are initially mixed and homogenized, at which point component (A) is stirred into the initially charged mixture, causing the pigment to become incipiently pasted and predispersed. The predispersion is subsequently, depending on the texture of the pigments used, finely dispersed or finely dissipated, with or without cooling, using a grinding or dispersing assembly. They include stirrers, dissolvers. (sawtooth stirrers), rotor-stator mills, ball mills, stirred media mills such as sand and bead mills, high speed mixers, kneaders, roll mills or high performance bead mills. The fine dispersion or grinding of the pigments is carried on to the desired particle size distribution and can take place at temperatures in the range from 0 to 100° C., advantageously at a temperature between 10 and 70° C. and preferably at a temperature in the range from 20 to 60° C. Following the operation of fine dispersion, the pigment formulation may be further diluted with water, preferably deionized or distilled water.

The pigment formulations of the present invention are useful for pigmenting and dyeing macromolecular materials of any kind, for example natural and synthetic fiber materials, preferably cellulose fibers, especially for paper pulp coloration and particularly for laminate coloration.

The pigment formulations of the present invention are further useful for pigmentation or production of painting and emulsion colors, emulsion paints, solventborne printing inks, including for example printing inks for textile, flexographic, decorative or gravure printing, wallpaper colors, water-thinnable paints, wood preservation systems, viscose dope dyeing systems, varnishes, sausage casings, seed, fertilizers, glass bottles, and also for mass coloration of roof shingles, for coloring renders, woodstains, colored pencil leads, felttip pens, waxes, paraffins, graphics inks, ballpoint pen pastes, chalks, washing and cleaning compositions, shoe care agents, latex products, abrasives, and also for coloring plastics or high molecular weight materials. High molecular weight organic materials are for example cellulose ethers and esters, such as ethylcellulose, nitrocellulose, cellulose acetate or cellulose butyrate, natural resins or artificial resins, such as addition polymerization resins or condensation resins, for example amino resins, especially urea- and melamine-formaldehyde resins, alkyd resins, acrylic resins, phenolic resins, polycarbonates, polyolefins, such as polystyrene, polyvinyl chloride, polyethylene, polypropylene, polyacrylonitrile, polyacrylic esters, polyamides, polyurethanes or polyesters, rubber, casein, latices, silicone, silicone resins, individually or in admixture.

The pigment formulations of the present invention are further useful for producing printing inks for use in all conventional ink jet printers, particularly for those based on the bubble jet or piezo process. These printing inks can be used to print paper and also natural or synthetic fiber materials, foils and plastics. Additionally the pigment formulations of the present invention can be used for printing various kinds of coated or uncoated substrate materials, for example for printing paperboard, cardboard, wood and woodbase materials, metallic materials, semiconductor materials, ceramic materials, glasses, glass and ceramic fibers, inorganic materials of construction, concrete, leather, comestibles, cosmetics; skin and hair. The substrate material may be two-dimensionally planar or spatially extended, i.e., three-dimensionally configured, and may be printed or coated completely or only in parts.

The pigment formulations of the present invention are further useful as a colorant in electrophotographic toners and developers, for example in one- or two-component powder toners (also called one- or two-component developers), magnetic toners, liquid toners, latex toners, polymerization toners and also specialty toners. Typical toner binders in this context are addition polymerization resins, polyaddition resins, polycondensation resins, such as styrene, styrene-acrylate, styrene-butadiene, acrylate, polyester, phenol-epoxy resins, polysulfones, polyurethanes, individually or in combination, and also polyethylene and polypropylene, which may each contain further ingredients, such as charge control agents, waxes or flow assistants, or are subsequently modified with these adjuvants.

The pigment formulations of the present invention are also useful as a colorant in powders and powder coatings, especially in triboelectrically or electrokinetically sprayable powder coatings, which are used to coat the surfaces of articles made for example of metal, wood, plastic, glass, ceramic, concrete, textile material, paper or rubber. Powder coating resins used here are typically epoxy resins, carboxyl- and hydroxyl-containing polyester resins, polyurethane resins and acrylic resins, together with the customary hardeners. Combinations of resins are also used. For instance, epoxy resins are frequently used in combination with carboxyl- and hydroxyl-containing polyester resins. Examples of typical hardener components (depending on the resin system) are acid anhydrides, imidazoles and also dicyandiamide and derivatives thereof, capped isocyanates, bisacylurethanes, phenolic resins, melamine resins, triglycidyl isocyanurates, oxazolines and dicarboxylic acids.

The pigment formulations of the present invention are also useful as a colorant in inks, preferably ink jet inks, for example aqueous or nonaqueous (solvent) based, microemulsion inks, UV-curable inks and also in those inks that operate by the hot melt process. Ink jet inks in general comprise in total 0.5% to 15% by weight and preferably 1.5% to 8% by weight (reckoned dry) of the pigment formulation of the present invention. Microemulsion inks are based on organic solvents, water and if appropriate an additional hydrotropic substance (interface mediator). Microemulsion inks comprise 0.5% to 15% by weight and preferably 1.5% to 8% by weight of the pigment formulation of the present invention, 5% to 99% by weight of water and 0.5% to 94.5% by weight of organic solvent and/or hydrotropic compound. Solventborne ink jet inks comprise preferably 0.5% to 15% by weight of the pigment formulation of the present invention, 85% to 99.5% by weight of organic solvent and/or hydrotropic compounds. UV-curable inks comprise essentially 0.5% to 30% by weight of the pigment formulation of the present invention, 0.5% to 95% by weight of water and 0.5% to 95% by weight of an organic solvent or solvent mixture, 0.5% to 50% by weight of a radiation-curable binder and if appropriate 0% to 10% by weight of a photoinitiator. Hot melt inks are usually based on waxes, fatty acids, fatty alcohols or sulfonamides which are solid at room temperature and liquefy on heating, the preferred melting range being between about 60° C. and about 140° C. Hot melt ink jet inks consist for example essentially of 20% to 90% by weight of wax and 1% to 10% by weight of the pigment formulation of the present invention. They may further include 0% to 20% by weight of an additional polymer (as “dye dissolver”), 0% to 5% by weight of dispersing assistant, 0% to 20% by weight of viscosity modifier, 0% to 20% by weight of plasticizer, 0% to 10% by weight of tack additive, 0% to 10% by weight of transparency stabilizer (which prevents crystallization of the waxes for example) and also 0% to 2% by weight of antioxidant.

The pigment formulations of the present invention are also useful as a colorant for color filters for flat panel displays, not only for additive but also subtractive color production, further for photoresists and also as a colorant for electronic inks (“e-inks”) or electronic paper (“e-paper”).

Color strength and hue were determined according to DIN 55986. Foamability was determined according to DIN 53902. Foaming was further determined by an internal method to simulate high flow velocities on the part of the dispersions. To this end, the dispersions were continuously squirted by means of a peristaltic pump into a glass cylinder at high flow velocity. Foamability was also determined using a Sita Foam Tester R-2000.

The pigment formulations were tested for shear stability using an internal method of measurement. To this end, the anionically charged pigments were flocculated in a cellulose suspension pulp simulator by means of cationic epichlorohydrin resins. Shearing was applied using a commercially available kitchen blender (Braun MX 32) set to a high speed of rotation. The pulp was then converted into paper and the color strength of a sheared dispersion was compared with that of an unsheared dispersion.

Dryout resistance was determined by drawing down the pigment formulation onto a polyester clearview film using a 200 μm doctor blade and storing the drawdown under standardized conditions. Dryout was determined after a few minutes, after half an hour, after one day and after three and seven days.

Viscosity was determined using a Roto Visco 1 cone-and-plate viscometer from Haake at 20° C. (titanium cone: ◯/ 60 mm, 1°), the dependence of viscosity on shear rate being investigated in a range between 0 and 200 s⁻¹. Viscosities were measured at a shear rate of 60 s⁻¹. The dispersions were assessed for storage stability by measuring their viscosity immediately after production of the formulation and also after four weeks of storage at 50° C. and after storage in a conditioning chamber at <0° C.

### EXAMPLES

Production of a Pigment Formulation

The pigment, in the form alternatively of powder, granulate or presscake, was pasted in deionized water together with the dispersants and the other adjuvants and then homogenized and predispersed using a dissolver (for example from VMA-Getzmann GmbH, type AE3-M1) or some other suitable apparatus. Fine dispersion was subsequently effected using a bead mill (for example AE3-M1 from VMA-Getzmann) or else some other suitable dispersing assembly, with milling being carried out with siliquartzite beads or zirconium mixed oxide beads of size d=1 mm, accompanied by cooling, until the desired color strength and coloristics were obtained. Thereafter, the dispersion was adjusted with deionized water to the desired final pigment concentration, the grinding media separated off and the pigment formulation isolated.

The pigment formulations described in the examples which follow were produced by the method described above, the following constituents being used in the stated amounts so as to produce 100 parts of the respective pigment formulation. Parts are by weight in the examples below.

### Example 1

35 parts of C.I. Pigment Red 176 (component A),
3 parts of dispersant of formula (I) where R¹=C₁₈H₃₅, n=8, X=CH₂COO⁻, M=Na⁺ (component B),
2.4 parts of dispersant of formula (II) where R², R³, R⁴=H, n=29 (average) (component C),
5 parts of polyethylene glycol ether of formula (VII) where n=10 (average) (component D),
0.5 part of compound of formula (IV) where R⁶=CH₃, R⁷=C₅H₁₁ (component E),
1 part of mixture of sodium salts of higher fatty acids corresponding to compound (VI): sodium salts of palmitic acid, cyprylic acid, capric acid, myristic acid, lauric acid, stearic acid, oleic acid, linoleic acid and linolenic acid (component F),
2 parts of sodium salt of a polymeric condensation product of 2-naphthalenesulfonic acid and formaldehyde (component H),
0.2 part of preservative
balance water.

The pigment formulation has a high color strength combined with a very clean hue. It proves to be free flowing and stable in storage, i.e., the sample remains free flowing despite hot storage at 50° C. for four weeks. According to DIN 53902, the formulation is to be rated foam free. Foam determination with peristaltic pump and glass cylinder leads to very little foaming after 3 minutes. The formulation's foamability determined using an R-2000 Sita Foam Tester is likewise determined to be quite minimal. The pigment formulation's shear stability must be rated very good. A sheared pulp produced from the formulation loses only 1% of color strength in a 5% paper pulp coloration compared with an unsheared pulp. The formulation further possesses high dryout resistance. It dries homogeneously, over 15 minutes, to a film which is elastic and does not crumble off the support. Even seven days later there is an elastic film which has not spalled off the support.

### Comparative Example 1a (without Component F)

35 parts of C.I. Pigment Red 176 (component A),
3 parts of dispersant of formula (I) where R¹=C₁₈H₃₅, n=8, X=CH₂COO⁻, M=Na⁺ (component B),
2.4 parts of dispersant of formula (II) where R², R³, R⁴=H, n=29 (average) (component C),
5 parts of polyethylene glycol ether of formula (VII) where n=10 (average) (component D),
0.5 part of compound of formula (I) where R⁶=CH₃, R⁷=C₅H₁₁ (component E),
2 parts of sodium salt of a polymeric condensation product of 2-naphthalenesulfonic acid and formaldehyde (component H),
0.2 part of preservative
balance water.

According to DIN 53902, the formulation foams moderately. Foam determination by peristaltic pump and glass cylinder leads to substantial foaming after 3 minutes. The formulation's foamability is likewise found to be very substantial.

### Example 2

45 parts of C.I. Pigment Blue 15:3 (component A),
1.5 parts of dispersant of formula (I) where R¹=C₁₈H₃₅, n=8, X=CH₂COO⁻, M=Na⁺ (component B),
4 parts of dispersant of formula (II) where R², R³, R⁴=H, n=29 (average) (component C),
8 parts of polyethylene glycol ether of formula (VII) where n=10 (average) (component D),
0.5 part of compound of formula (IV) where R⁶=CH₃, R⁷=C₅H₁₁ (component E),
0.1 part of mixture of sodium salts of higher fatty acids corresponding to compound (VI): sodium salts of palmitic acid, cyprylic acid, capric acid, myristic acid, lauric acid, stearic acid, oleic acid, linoleic acid and linolenic acid (component F),
2.5 parts of sodium salt of a polymeric condensation product of 2-naphthalenesulfonic acid and formaldehyde (component H),
0.9 part of preservative
balance water.

The pigment formulation has a high color strength combined with a very clean hue. It proves to be free flowing and stable in storage, i.e., the sample remains free flowing despite hot storage at 50° C. for four weeks. According to DIN 53902, the formulation is to be rated foam free. Foam determination with peristaltic pump and glass cylinder leads to very little foaming after 3 minutes. The formulation's foamability is likewise determined to be quite minimal. The pigment formulation's shear stability must be rated very good. A sheared pulp produced from the formulation loses only 3% of color strength in a 5% paper pulp coloration compared with an unsheared pulp. The formulation further possesses high dryout resistance. It dries homogeneously, over 10 minutes, to a film which is elastic and does not crumble off the support. Even seven days later there is an elastic film which has not spalled off the support.

### Comparative Example 2a (without Component C)

45 parts of C.I. Pigment Blue 15:3,
5.5 parts of dispersant of formula (I) where R¹=C₁₈H₃₅, n=8, X=CH₂COO⁻, M=Na⁺ (component B),
8 parts of polyethylene glycol ether of formula (VII) where n=10 (average) (component D),
0.5 part of compound of formula (IV) where R⁶=CH₃, R⁷=C₅H₁₁,
0.1 part of mixture of sodium salts of higher fatty acids corresponding to compound (VI): sodium salts of palmitic acid, cyprylic acid, capric acid, myristic acid, lauric acid, stearic acid, oleic acid, linoleic acid and linolenic acid,
2.5 parts of sodium salt of a polymeric condensation product of 2-naphthalenesulfonic acid and formaldehyde,
0.9 part of preservative
balance water.

Stability in storage is poor, since the dispersion solidifies in the course of four weeks of storage at 50° C.

### Example 3

42 parts of C.I. Pigment Red 170,
1.5 parts of dispersant of formula (I) where R¹=C₁₈H₃₅, n=8, X=CH₂COO⁻, M=Na⁺ (component B),
4.5 parts of dispersant of formula (II) where R², R³, R⁴=H, n=29 (average),
5 parts of polyethylene glycol ether of formula (VII) where n=10 (average),
0.5 part of compound of formula (IV) where R⁶=CH₃, R⁷=C₅H₁₁,
0.2 part of mixture of sodium salts of higher fatty acids corresponding to compound (VI): sodium salts of palmitic acid, cyprylic acid, capric acid, myristic acid, lauric acid, stearic acid, oleic acid, linoleic acid and linolenic acid,
0.2 part of preservative
balance water.

The pigment formulation has a high color strength combined with a very clean hue. It proves to be free flowing and stable in storage, i.e., the sample remains free flowing despite hot storage at 50° C. for four weeks. According to DIN 53902, the formulation is to be rated low foaming. Foam determination with peristaltic pump and glass cylinder leads to very little foaming after 3 minutes. The formulation's foamability is likewise determined to be minimal. The pigment formulation's shear stability must be rated very good. A sheared pulp produced from the formulation loses only 1% of color strength in a 5% paper pulp coloration compared with an unsheared pulp. The formulation further possesses high dryout resistance. It dries homogeneously, over 20 minutes, to a film which is elastic and does not crumble off the support. Even seven days later there is an elastic film which has not spalled off the support.

### Comparative Example 3a (without Component D)

42 parts of C.I. Pigment Red 170,
1.5 parts of dispersant of formula (I) where R¹=C₁₈H₃₅, n=8, X=CH₂COO⁻, M=Na⁺ (component B),
4.5 parts of dispersant of formula (II) where R², R³, R⁴=H, n=2 (average),
5 parts of ethylene glycol,
0.5 part of compound of formula (IV) where R⁶=CH₃, R⁷=C₅H₁₁,
0.2 part of mixture of sodium salts of higher fatty acids corresponding to compound (VI): sodium salts of palmitic acid, cyprylic acid, capric acid, myristic acid, lauric acid, stearic acid, oleic acid, linoleic acid and linolenic acid,
0.2 part of preservative
balance water.

Dryout resistance of this pigment formulation is poor. The dispersion dries out within 10 minutes and crumbles brittly off the support material.

### Example 4

40 parts of C.I. Pigment Yellow 16,
3 parts of dispersant of formula (I) where R¹=C₁₈H₃₅, n=8, X=CH₂COO⁻, M=Na⁺ (component B),
2.5 parts of dispersant of formula (II) where R², R³, R⁴=H, n=20 (average),
5 parts of polyethylene glycol ether of formula (VII) where n=10 (average),
0.5 part of compound of formula (IV) where R⁶=CH₃, R⁷=C₅H₁₁,
0.1 part of mixture of sodium salts of higher fatty acids corresponding to compound (VI): sodium salts of palmitic acid, cyprylic acid, capric acid, myristic acid, lauric acid, stearic acid, oleic acid, linoleic acid and linolenic acid,
0.2 part of preservative
balance water.

The pigment formulation has a high color strength combined with a clean hue. It proves to be free flowing and stable in storage, i.e., the sample remains free flowing despite hot storage at 50° C. for four weeks. According to DIN 53902, the formulation is to be rated foam free. Foam determination with peristaltic pump and glass cylinder leads to no foaming after 3 minutes. The formulation's foamability is minimal. The pigment formulation's shear stability must be rated good. A sheared pulp produced from the formulation loses 3% of color strength in a 5% paper pulp coloration compared with an unsheared pulp. The formulation further possesses high dryout resistance. It dries homogeneously, over 20 minutes, to a film which is elastic and does not crumble off the support. Even seven days later there is an elastic film which has not spalled off the support.

### Comparative Example 4a (without Component B)

40 parts of C.I. Pigment Yellow 16,
3 parts of dispersant of formula (II) where R², R³, R⁴=H, n=20 (average),
2.5 parts of dispersant of formula (III) where R², R³, R⁴=H, n=20 (average), X=PO₃M⁻, M=(HO—CH₂—CH₂—)₃NH⁺,
5 parts of polyethylene glycol ether of formula (VII) where n=10 (average),
0.5 part of compound of formula (IV) where R⁶=CH₃, R⁷=C₅H₁₁,
0.1 part of mixture of sodium salts of higher fatty acids corresponding to compound (VI): sodium salts of palmitic acid, cyprylic acid, capric acid, myristic acid, lauric acid, stearic acid, oleic acid, linoleic acid and linolenic acid,
0.2 part of preservative
balance water.

Compared with Example 4, shear stability is poor. A sheared pulp prepared from the formulation loses 15% of color strength in a 5% paper pulp coloration compared with an unsheared pulp.

### Example 5

48 parts of C.I. Pigment Red 112,
2.2 parts of dispersant-of formula (I) where R¹=C₁₈H₃₅, n=8, X=CH₂COO⁻, M=Na⁺ (component B),
4.4 parts of dispersant of formula (II) where R², R³, R⁴=H, n=29 (average),
5 parts of polyethylene glycol ether of formula (VII) where n=10 (average),
1 part of compound of formula (IV) where R⁶=CH₃, R⁷=C₅H₁₁,
1 part of mixture of sodium salts of higher fatty acids corresponding to compound (VI): sodium salts of palmitic acid, cyprylic acid, capric acid, myristic acid, lauric acid, stearic acid, oleic acid, linoleic acid and linolenic acid,
5 parts of sodium salt of a polymeric condensation product of 2-naphthalenesulfonic acid and formaldehyde,
0.2 part of preservative
balance water.

The pigment formulation has a high color strength combined with a very clean hue. It proves to be free flowing and stable in storage, i.e., the sample remains free flowing despite hot storage at 50° C. for four weeks. According to DIN 53902, the formulation exhibits low foaming. Foam determination with peristaltic pump and glass cylinder leads to very little foaming after 3 minutes. The formulation's foamability is likewise determined to be relatively minimal. The pigment formulation's shear stability must be rated good. A sheared pulp produced from the formulation loses only 2% of color strength in a 5% paper pulp coloration compared with an unsheared pulp. The formulation further possesses high dryout resistance. It dries homogeneously, over 30 minutes, to a film which is elastic and does not crumble off the support. Even seven days later there is an elastic film which has not spalled off the support.

### Comparative Example 5a (without Component E)

48 parts of C.I. Pigment Red 112,
2.2 parts of dispersant of formula (I) where R¹=C₁₈H₃₅, n=8, X=CH₂COO⁻, M=Na⁺ (component B),
4.4 parts of dispersant of formula (II) where R², R³, R⁴=H, n=29 (average),
5 parts of polyethylene glycol ether of formula (VII) where n=10 (average),
1 part of mixture of sodium salts of higher fatty acids corresponding to compound (VI): sodium salts of palmitic acid, cyprylic acid, capric acid, myristic acid, lauric acid, stearic acid, oleic acid, linoleic acid and linolenic acid,
5 parts of sodium salt of a polymeric condensation product of 2-naphthalenesulfonic acid and formaldehyde,
0.2 part of preservative
balance water.

According to DIN 53902, the formulation foams substantially. Foam determination by peristaltic pump and glass cylinder leads to very high foaming after 3 minutes.

### Comparative Example 5b (without Component B)

48 parts of C.I. Pigment Red 112,
2.2 parts of Hostapur SAS 30® (alkylsulfonate, sodium salt),
4.4 parts of dispersant of formula (II) where R², R³, R⁴=H, n=29 (average),
5 parts of polyethylene glycol ether of formula (VII) where n=10 (average),
1 part of compound of formula (IV) where R⁶=CH₃, R⁷=C₅H₁₁,
1 part of mixture of sodium salts of higher fatty acids corresponding to compound (VI): sodium salts of palmitic acid, cyprylic acid, capric acid, myristic acid, lauric acid, stearic acid, oleic acid, linoleic acid and linolenic acid,
5 parts of sodium salt of a polymeric condensation product of 2-naphthalenesulfonic acid and formaldehyde,
0.2 part of preservative
balance water.

According to DIN 53902, the formulation foams substantially. Foam determination by peristaltic pump and glass cylinder leads to very high foaming after 3 minutes.

### Example 6

The acrylate resin solution used in this example is known from DE-A-101 35 140. The polyacrylate is a copolymer of 50-70% of styrene, 20-40% of acrylic or methacrylic acid and 5-15% of esters of acrylic or methacrylic acid. The acrylate solution consists of 25% by weight of the dissolved polymer, 3.9% by weight of NaOH and 71.1% by weight of water.
45 parts of C.I. Pigment Yellow 97,
2 parts of dispersant of formula (I) where R¹=C₁₈H₃₅, n=8, X=CH₂COO⁻,
M=Na⁺ (component B),
1.2 parts of dispersant of formula (II) where R², R³, R⁴=H, n=29 (average),
7.5 parts of polyethylene glycol ether of formula (VII) where n=10 (average),
0.5 part of compound of formula (IV) where R⁶=CH₃, R⁷=C₅H₁₁,
0.1 part of mixture of sodium salts of higher fatty acids corresponding to compound (VI): sodium salts of palmitic acid, cyprylic acid, capric acid, myristic acid, lauric acid, stearic acid, oleic acid, linoleic acid and linolenic acid,
12 parts of 25% acrylate resin solution,
0.2 part of preservative
balance water.

The pigment formulation is equivalent to Example 1 with regard to color strength, storage stability, foamability, shear stability and dryout resistance.

### Example 7

30 parts of C.I. Pigment Violet 23,
2.3 parts of dispersant of formula (I) where R¹=C₁₈H₃₅, n=8, X=CH₂COO⁻, M=Na⁺ (component B),
4 parts of dispersant of formula (II) where R², R³, R⁴=H, n=29 (average),
5 parts of polyethylene glycol ether of formula (VII) where n=10 (average),
0.6 part of compound of formula (IV) where R⁶=CH₃, R⁷=C₅H₁₁,
0.1 part of mixture of sodium salts of higher fatty acids corresponding to compound (VI): sodium salts of palmitic acid, cyprylic acid, capric acid, myristic acid, lauric acid, stearic acid, oleic acid, linoleic acid and linolenic acid,
4 parts of sodium salt of a polymeric condensation product of 2-naphthalenesulfonic acid and formaldehyde,
0.2 part of preservative
balance water.

The pigment formulation is equivalent to Example 1 with regard to color strength, storage stability, foamability, shear stability and dryout resistance.

1. An aqueous pigment formulation comprising
(A) at least one organic pigment, inorganic pigment, or a mixture thereof
(B) at least one polyethylene glycol alkyl ether functionalized with a terminal acid group,
(C) at least one alkoxylated styrene-phenol condensate,
(D) at least one polyethylene glycol ether having an average molar mass between 200 and 1000 g/mol,
(E) at least one alkynediol,
(F) fats and oils of vegetable or animal origin, saturated and unsaturated higher fatty acids of the fats and oils of vegetable or animal origin, salts of the saturated and unsaturated higher fatty acids or a mixture thereof,
(G) optionally, an aqueous acrylate resin solution,
(H) optionally, a polymeric condensation product of aromatic sulfonic acids and formaldehyde, the salts of aromatic sulfonic acids and formaldehyde or a mixture thereof,
(I) optionally, a sulfosuccinic monoester of a castor oil alkoxylate,
(J) optionally, a hydrotropic substance,
(L) water.

2. The pigment formulation according to claim 1 comprising essentially
(A) 5% to 80% by weight of the at least one organic pigment, inorganic pigment or mixture thereof,
(B) 0.1% to 30% by weight of the at least one polyethylene glycol alkyl ether functionalized with a terminal acid group,
(C) 0.1% to 30% by weight of the at least one alkoxylated styrene-phenol condensate,
(D) 0.5% to 50% by weight of the at least one polyethylene glycol ether having an average molar mass between 200 and 1000 g/mol,
(E) 0.1% to 5% by weight of the at least one alkynediol,
(F) 0.1% to 10% by weight of the fats and oils of vegetable or animal origin, saturated and unsaturated higher fatty acids of the fats and oils of vegetable or animal origin, salts of the saturated and unsaturated higher fatty acids or a mixture thereof,
(G) 0% to 30% by weight of the aqueous acrylate resin solution,
(H) 0% to 10% by weight of the polymeric condensation product of aromatic sulfonic acids and formaldehyde, the salts of aromatic sulfonic acids and formaldehyde or a mixture thereof,
(I) 0% to 10% by weight of the sulfosuccinic monoester of a castor oil alkoxylate,
(J) 0% to 30% by weight of the hydrotropic substance,
(L) 5% to 90% by weight of the water,
all based on the total weight of the pigment formulation.

3. The pigment formulation according to claim 1 comprising essentially
(A) 20% to 70% by weight of the at least one organic pigment, inorganic pigment or mixture thereof,
(B) 1% to 15% by weight of the at least one polyethylene glycol alkyl ether functionalized with a terminal acid group,
(C) 1% to 15% by weight of the at least one alkoxylated styrene-phenol condensate,
(D) 1% to 20% by weight of the at least one polyethylene glycol ether having an average molar mass between 200 and 1000 g/mol,
(E) 0.1% to 2% by weight of the at least one alkynediol,
(F) 0.1% to 5% by weight of the fats and oils of vegetable or animal origin, saturated and unsaturated higher fatty acids of the fats and oils of vegetable or animal origin, salts of the saturated and unsaturated higher fatty acids or a mixture thereof,
(G) 0% to 25% by weight of the aqueous acrylate resin solution,
(H) 0% to 5% by weight of the polymeric condensation product of aromatic sulfonic acids and formaldehyde, the salts of aromatic sulfonic acids and formaldehyde or a mixture thereof,
(I) 0% to 8% by weight of the sulfosuccinic monoester of a castor oil ethoxylate,
(J) 0% to 20% by weight of the hydrotropic substance,
(L) 10% to 70% by weight of the water,
all based on the total weight of the pigment formulation.

4. The pigment formulation according to claim 1, wherein said component (A) is at least one pigment selected from the group consisting of monoazo, disazo, laked azo, β-naphthol, Naphthol AS, benzimidazolone, disazo condensation, azo metal complex, phthalocyanine, quinacridone, perylene, perinone, thioindigo, anthanthrone, anthraquinone, flavanthrone, indanthrone, isoviolanthrone, pyranthrone, dioxazine, quinophthalone, isoindoline, isoindolinone or diketopyrrolopyrrole pigments, an acidic to alkaline carbon black selected from the group consisting of furnace blacks and lamp blacks, and a mixture thereof.

5. The pigment formulation according to to claim 1, wherein component A) is an organic pigment combined with carbon black or titanium dioxide.

6. The pigment formulation according to claim 1, wherein the polyethylene glycol alkyl ether (B) functionalized with a terminal acid group is a compound of the formula (I): 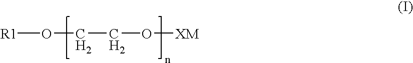
where
R¹ is a substituted or unsubstituted, branched or unbranched C₁-C₂₀-alkyl or C₃-C₂₀-cycloalkyl radical or a substituted or unsubstituted, branched or unbranched C₂-C₂₀-alkenyl or C₃-C₂₀-cycloalkenyl radical, the substituents being 1, 2, 3 or 4 radicals selected from the group consisting of halogen, aryl, aryl(C₁-C₂₀)alkyl, C₅-C₆-cycloalkyl, hetaryl, hetaryl(C₁-C₂₀)alkyl and C₁-C₂₀-alkoxy,
n is a number from 1 to 100,
X is SO₃⁻, SO₂⁻, CH₂COO⁻, PO₃²⁻ or PO₃M⁻, and
M is H, a monovalent metal cation, a divalent metal cation, NH₄⁺, a secondary, tertiary or quaternary ammonium ion, or a combination thereof.

7. The pigment formulation according to claim 1, wherein the alkoxylated styrene-phenol condensate is a compound of the formula (II) or (III) or a mixture thereof: 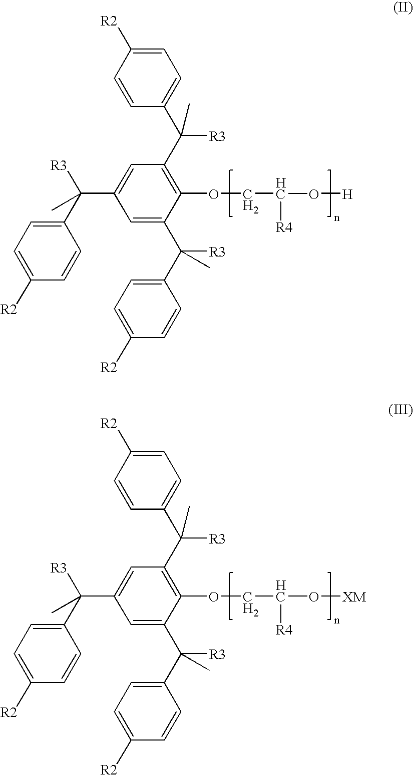
where
R² is H, a branched or unbranched C₁-C₂₀-alkyl or C₃-C₂₀-cycloalkyl radical, branched or unbranched C₂-C₂₀-alkenyl or C₃-C₂₀-cycloalkenyl radical,
R³ and R⁴ are independently H, a branched or unbranched C₁-C₂₀-alkyl or
C₃-C₂₀-cycloalkyl radical ea branched or unbranched C₂-C₂₀-alkenyl or
C₃-C₂₀-cycloalkenyl radical,
n is a number from 1 to 100,
X is CO—R⁵—COO⁻, SO₃⁻, SO₂⁻, PO₃²⁻ or PO₃M⁻,
R⁵ is a substituted or unsubstituted, branched or unbranched C₁-C₂₀-alkylene radical, a substituted or unsubstituted, branched or unbranched C₂-C₂₀-alkenylene radical, or a substituted or unsubstituted arylene radical, and
M is H, a monovalent metal cation, a divalent metal cation, NH₄⁺, a secondary, tertiary or quaternary ammonium ion.

8. The pigment formulation according to claim 1, wherein the alkynediol is a compound of the formula (IV) or (V) or a mixture thereof: 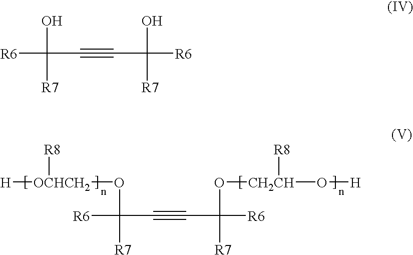
where
R⁶ is H or a branched or unbranched C₁-C₄-alkyl radical or a branched or unbranched C₂-C₄-alkenyl radical,
R⁷ is a branched or unbranched C₃-C₂₀-alkyl or C₃-C₂₀-cycloalkyl radical or a branched or unbranched C₃-C₂₀-alkenyl or C₃-C₂₀-cycloalkenyl radical,
R⁸ is H, a branched or unbranched C₁-C₂₀-alkyl or C₃-C₂₀-cycloalkyl radical or a branched or unbranched C₂-C₂₀-alkenyl or C₃-C₂₀-cycloalkenyl radical,
n is a number from 1 to 100.

9. The pigment formulation according to one claim 1, wherein the component (F) is a compound of the formula (VI) or a mixture thereof:
R9—COO—M (VI)
where
R⁹ is a branched or unbranched C₇-C₂₉-alkyl, a branched or unbranched C₇-C₂₉-alkenyl radical, a branched or unbranched C₇-C₂₉-alkdienyl radical or a branched or unbranched C₇-C₂₉-alktrienyl radical, and
M is H, a monovalent metal cation, NH₄⁺, a secondary, tertiary or quaternary ammonium ion,
or a fat or oil selected from the group consisting of tallow, palm kernel fat, coco fat, rapeseed oil, sunflower oil, linseed oil, palm oil, soya oil, peanut oil and whale oil.

10. A process for producing a pigment formulation according to claim 1, comprising the steps of incipiently pasting and homogenizing in water the component (A) together with said components (B), (C), (D), (E), (F) and optionally (G), (H), (I), (J) to form a mixture and finely dispersing or finely dissipating the mixture with a grinding or dispersing assembly.

11. A pigmented natural or synthetic material pigmented with the pigment formulation according to claim 1.

12. A pigmented natural or synthetic fiber material pigmented with the pigment formulation according to claim 1.

13. A pigmentation composition or pigmented article comprising a pigment formulation according to claim 1, wherein the pigmentation composition or pigmented article is in the form of waterborne printing inks, ink jet inks, electrophotographic toners, powder coatings, color filters, electronic inks, electronic paper, painting and emulsion colors, emulsion paintings, solventborne printing inks, wallpaper colors, water-thinnable paintings, wood preservation systems, viscose dope dyeing, sausage casings, seed, fertilizers, glass bottles, roof shingles, coloring renders, woodstains, colored pencil leads, felttip pens, waxes, paraffins, graphics inks, ballpoint pen pastes, chalks, washing compositions, cleaning compositions, shoe care agents, latex products, abrasives or colored plastics.

14. The pigment formulation according to claim 6, wherein the substituents for R⁵ are 1, 2, 3 or 4 radicals selected from the group consisting of halogen, hydroxyl, C₁-C₄-alkoxy, nitro, cyano, carboxyl, amino and sulfo.

15. The pigmented natural or synthetic fiber material according to claim 13, wherein the pigmented natural or synthetic fiber material is cellulose fibers.

16. The pigmented natural or synthetic fiber material according to claim 15, wherein the cellulosic fibers are for paper pulp coloration or laminate coloration.
